(19) United States
(12) Patent Application Publication
(10) Pub. No.: US 2014/0145435 A1
(43) Pub. Date: May 29, 2014

(54) TUBE CONNECTOR SEALING STRUCTURE AND TUBE CONNECTOR

(71) Applicants: Libo Zhu, Cixi Zhejiang (CN); Jianjiang Lin, Cixi Zhejiang (CN)

(72) Inventors: Libo Zhu, Cixi Zhejiang (CN); Jianjiang Lin, Cixi Zhejiang (CN)

(73) Assignee: NINGBO SANLING ELECTRONICS CO., LTD., Cixi Zhejiang (CN)

(21) Appl. No.: 13/974,317

(22) Filed: Aug. 23, 2013

(30) Foreign Application Priority Data
Nov. 26, 2012 (CN) 201210484870.1

(51) Int. Cl. F16L 19/04

(52) U.S. Cl. CPC F16L 19/041
USPC 285/355; 277/608

(57) ABSTRACT

The present application provides a tube connector sealing structure configured to seal connecting portions among a tube, a connector main body and a nut, including a sealing ring, a supporting ring, and a retaining ring which are all arranged at an outer side of the tube, wherein an outer side end of the retaining ring and an outer side end of the sealing ring respectively abut against a threaded end opening of the connector main body and a clamping end of the nut, and one end of the supporting ring presses against an inner side end of the retaining ring, and a right angled cooperative connection is formed between the other end of the supporting ring and an inner side end of the sealing ring. The present application further discloses a tube connector having the above tube connector sealing structure.

### CROSS REFERENCE TO RELATED APPLICATIONS

The application relates to and claims the benefit of priority to Chinese Patent Application No. 201210484870.1 titled “TUBE CONNECTOR SEALING STRUCTURE AND TUBE CONNECTOR”, filed on Nov. 26, 2012, the entire disclosure of which is incorporated herein by reference.

### FIGURE SELECTED FOR PUBLICATION

FIG. 6

### FIELD OF THE INVENTION

The present application relates to a technical field of tube connectors, in particular to a tube connector sealing structure, and further relates to a tube connector having the above tube connector sealing structure.

### BACKGROUND OF THE INVENTION

EMT (electrical-metallic tubing) is a common wiring tube, and generally an end portion of the EMT is connected by a tube connector.

A tube connector in the prior art is described hereinafter in conjunction with accompanying drawings. Reference is made to FIG. 1, wherein FIG. 1 is a schematic view showing the structure of a conventional tube connector.

The tube connector generally includes a connector main body 1′, a nut 2′, a sealing ring 4′, a supporting ring 5′ and a retaining ring 6′. The sealing ring 4′, the supporting ring 5′ and the retaining ring 6′ are arranged at an outer side of the EMT (referred to as a tube 3′ in the present application), and are inserted into an inner hole of the connector main body 1′ together with the tube 3′. At least one end of the connector main body 1′ is a threaded connection end having a male thread for engaging with the nut 2′ having a female thread. The nut 2′ has one end connected with the threaded connection end of the connector main body 1′, and the other end forming a clamping end for clamping the retaining ring 6′. When tightening the nut 2′, the nut 2′ tightly presses the retaining ring 6′, and in turn tightly presses the tube 3′, so as to realize the fixed connection between the tube 3′ and the connector main body 1′.

Specifically, the sealing ring 4′ is provided to prevent external water from entering into the tube 3′ along connecting portions among the nut 2′, the tube 3′ and the connector main body 1′. One end of the sealing ring 4′ abuts against an end opening of the threaded connection end of the connector main body 1′, an end surface of the other end of the sealing ring 4′ abuts against an end surface of the supporting ring 5′, and the other end of the supporting ring 5′ presses against the retaining ring 6′. Specifically, the end of the retaining ring 4′ abutting against the supporting rig 5′ is a plane, and the corresponding end of the supporting ring 5′ is also a plane, that is, an abutting surface of each of the retaining ring 4′ and the supporting ring 5′ is a plane.

The above cooperation structure of the sealing ring 4′ and the supporting ring 5′ may cause the following problems. When mounting the sealing ring 4′ and the supporting ring 5′, since the contact between the sealing ring 4′ and the supporting ring 5′ is a planar contact, the sealing ring 4′ is apt to be dislocated or play along a radial direction of the tube 3′, and generally the sealing ring 4′ is a flexible member, thus the sealing ring 4′ is apt to be stuck into a gap between the retaining ring 6′ and the connector main body 1′, such that the sealing member cannot closely abut against the supporting ring 5′ and the end opening of the threaded connection end of the connector main body 1′, thus the sealing effect fails, and the water proofing effect can not be provided. Furthermore during the use process of the tube connector, due to the planar contact between the sealing ring 4′ and the supporting ring 5′, a gap exists between the sealing ring 4′ and the supporting ring 5′, which causes a poor sealing effect.

Therefore, a technical problem to be solved presently by those skilled in the art is to prevent the dislocation of the sealing ring and improve the sealing effect of the tube connector.

### SUMMARY OF THE INVENTION

A first aspect of the present application is to provide a tube connector sealing structure, which can prevent the dislocation of the sealing ring and improve the sealing effect of the tube connector. A second aspect of the present application is to provide a tube connector having the above tube connector sealing structure.

For achieving the above first object, the present application provides a tube connector sealing structure, configured to seal connecting portions among a tube, a connector main body and a nut, including a sealing ring, a supporting ring, and a retaining ring which are all arranged at an outer side of the tube, wherein an outer side end of the retaining ring and an outer side end of the sealing ring respectively abut against a threaded end opening of the connector main body and a clamping end of the nut, or an outer side end of the retaining ring and an outer side end of the sealing ring respectively abut against a clamping end of the nut and a threaded end opening of the connector main body; and one end of the supporting ring presses against an inner side end of the retaining ring, and a right angled cooperative connection is formed between the other end of the supporting ring and an inner side end of the sealing ring.

Preferably, the inner side end of the sealing ring has a right angled groove, a corresponding end of the supporting ring has a right angled protrusion, and a right angled cooperative connection is formed by the right angled groove and the right angled protrusion.

Preferably, a front end surface of the right angled groove is an inclined surface, and a rear end surface of the right angled protrusion abuts against the inclined surface.

Preferably, an inner side end of the sealing ring has a right angled protrusion, a corresponding end of the supporting ring has a right angled groove, and a right angled cooperative connection is formed by the right angled groove and the right angled protrusion.

Preferably, one end of the supporting ring is an inclined surface configured to press against the inner side end of the retaining ring.

Preferably, end surfaces of the outer side end of the retaining ring and the outer side end of the sealing ring respectively abut against the threaded end opening of the connector main body and an end surface of the clamping end of the nut; or end surfaces of the outer side end of the retaining ring and the outer side end of the sealing ring respectively abut against an end surface of the clamping end of the nut and the threaded end opening of the connector main body.

The tube connector sealing structure according to the present application includes a sealing ring, a supporting ring, and a retaining ring which are all arranged at an outer side of the tube, wherein an outer side end of the retaining ring and an outer side end of the sealing ring respectively abut against a threaded end opening of the connector main body and a clamping end of the nut, or an outer side end of the retaining ring and an outer side end of the sealing ring respectively abut against a clamping end of the nut and a threaded end opening of the connector main body; and one end of the supporting ring presses against an inner side end of the retaining ring, and a right angled cooperative connection is formed between the other end of the supporting ring and an inner side end of the sealing ring.

In the tube connector sealing structure having the above structure, contact surfaces of the sealing ring and the supporting ring abut against with each other in the right angled cooperative connection manner. When mounting the sealing ring and the supporting ring, the sealing ring may be closely connected with the supporting ring, such that the right angled cooperative connection structure between the sealing ring and the supporting ring may limit the position of the sealing ring in a radial direction of the tube, which may prevent the sealing ring from being dislocated or playing in the radial direction of the tube, and prevent the sealing ring from being stuck in a gap between the retaining ring and the connector main body, such that the sealing member may closely abut against the supporting ring, an outer wall of the tube, and the end surface of the threaded connecting end of the connector main body, thereby ensuring the sealing effect. Furthermore, a contact gap between the sealing ring and the supporting ring is of an L shape, such that a path through which the external water enters is changed, and a difficulty for the entering of the external water is increased, thereby improving the sealing effect.

For achieving the second aspect, the present application further provides a connector main body, each of two ends of the connector main body having a threaded connecting end, wherein at least one threaded connecting end of the connector main body is connected with a nut, a tube, and the above tube connector sealing structure. Since the above tube connector sealing structure has the above technical effects, the tube connector having the above tube connector sealing structure should also have the corresponding technical effects.

Preferably, the threaded connecting end at each of the two ends of the connector main body is connected with a nut, a tube, and the above tube connector sealing structure.

Preferably, the threaded connecting end at one end of the connector main body is connected with a nut, a tube, and the above tube connector sealing structure, and the threaded connecting end at the other end of the connector main body is connected with a locknut and a stop collar.

### BRIEF DESCRIPTION OF THE DRAWINGS

FIG. 1 is a schematic view showing the structure of a conventional tube connector;

FIG. 2 is a schematic view showing the structure of a tube connector sealing structure according to a first embodiment of the present application;

FIG. 3 is an exploded schematic view showing the structure of the tube connector sealing structure in FIG. 2;

FIG. 4 is a partial enlarged schematic view showing the structure of the cooperation among a sealing member, a retaining ring, and a supporting ring in FIG. 2;

FIG. 5 is a partial enlarged schematic view showing the structure of the cooperation between the sealing member and the supporting ring in FIG. 4;

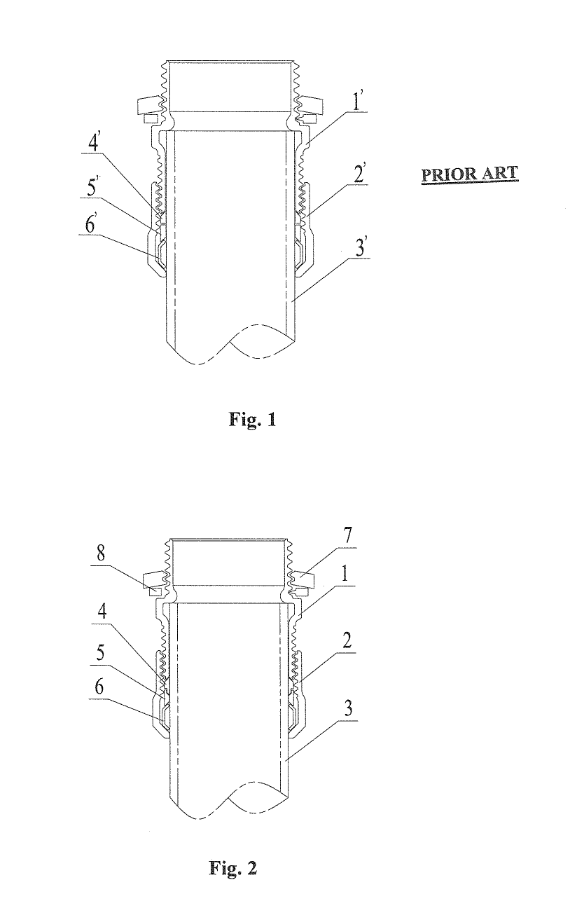

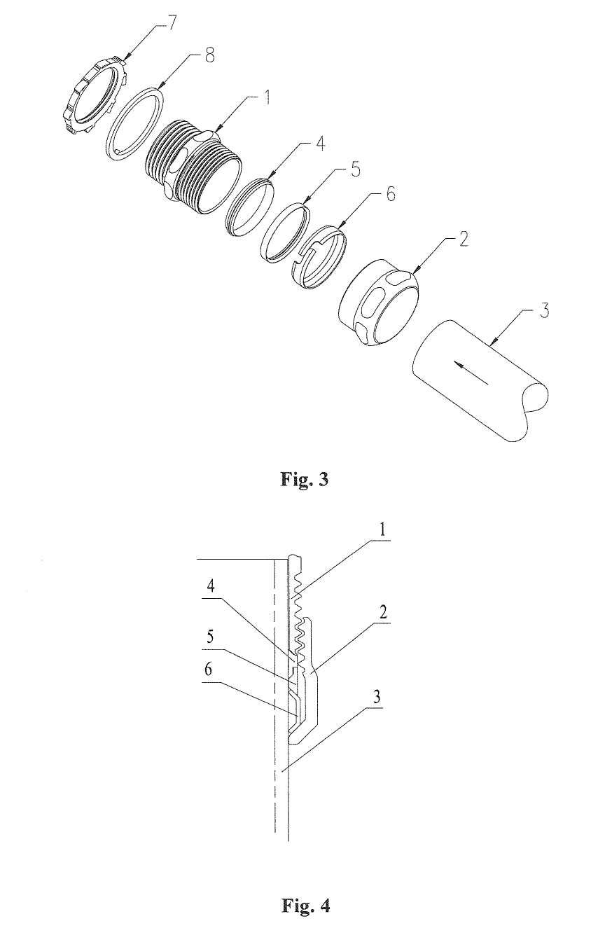

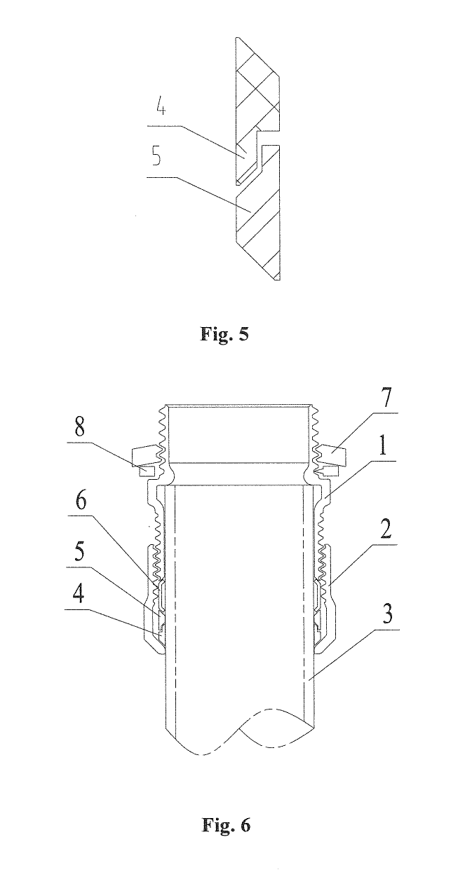

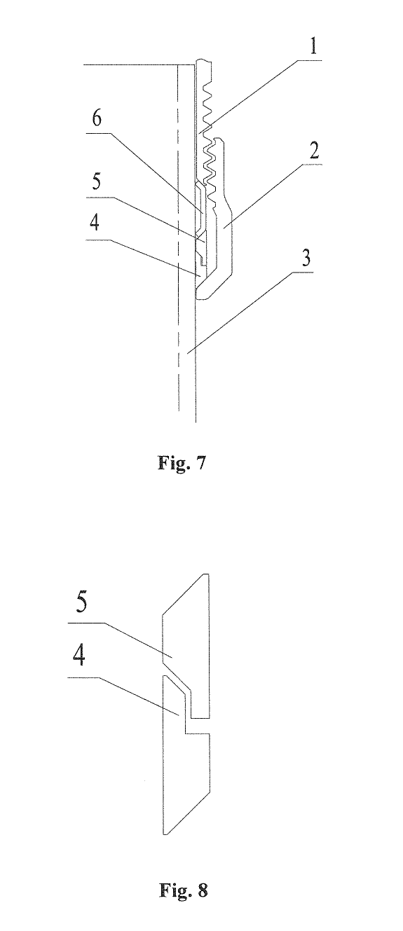

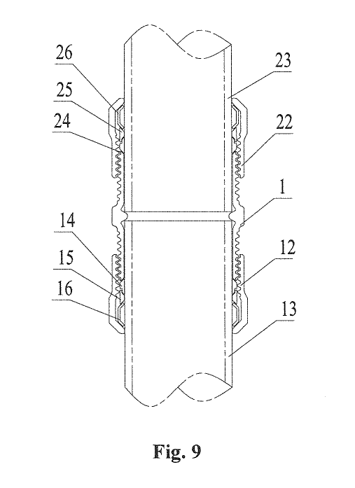

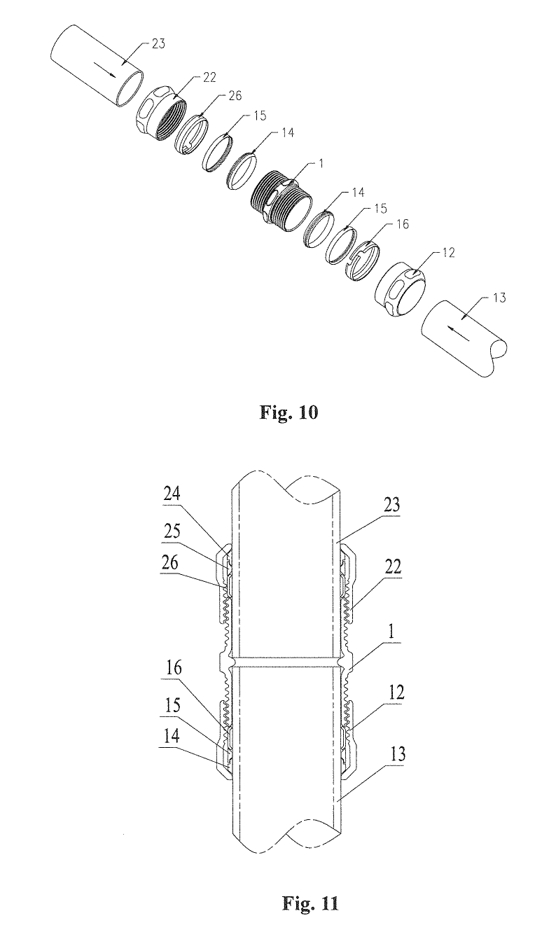

FIG. 6 is a schematic view showing the structure of a tube connector sealing structure according to a second embodiment of the present application;

FIG. 7 is a partial enlarged schematic view showing the structure of the cooperation among a sealing member, a retaining ring, and a supporting ring in FIG. 6;

FIG. 8 is a partial enlarged schematic view showing the structure of the cooperation between the sealing member and the supporting ring in FIG. 7;

FIG. 9 is a schematic view showing the structure of a tube connector according to an embodiment of the present application;

FIG. 10 is an exploded schematic view showing the structure of the tube connector in FIG. 9; and

FIG. 11 is a schematic view showing the structure of a tube connector according to another embodiment of the present application.

Reference numerals in FIGS. 1 to 11:

| | | |
|---|---|---|
| 1′ connector main body, | 2′ nut, | 3′ tube, |
| 4′ sealing ring, | 5′ supporting ring, | 6′ retaining ring; |
| 1 connector main body, | 2 nut, | 3 tube, |
| 4 sealing ring, | 5 supporting ring, | 6 retaining ring, |
| 7 locknut, | 8 stop collar; | |
| 12 first nut, | 13 first tube, | 14 first sealing ring, |
| 15 first supporting ring, | 16 first retaining ring; | |
| 22 second nut; | 23 second tube, | 24 second sealing ring, |
| 25 second supporting | 26 second retaining | |
| ring, and | ring. | |

### DETAILED DESCRIPTION OF THE INVENTION

For those skilled in the art to better understand technical solutions of the present application, the present application will be described in detail in conjunction with drawings and embodiments hereinafter.

Reference is made to FIG. 2 and FIG. 3, wherein FIG. 2 is a schematic view showing the structure of a tube connector sealing structure according to a first embodiment of the present application; and FIG. 3 is an exploded schematic view showing the structure of the tube connector sealing structure in FIG. 2.

As shown in FIG. 2 and FIG. 3, the tube connector sealing structure according to the present application is provided to seal connecting portions among a tube 3, a connector main body 1 and a nut 2, and includes a sealing ring 4, a supporting ring 5, and a retaining ring 6 which are all arranged at an outer side of the tube 3. In an embodiment, the connector main body 1 is a tubular structure having an inner hole, and includes at least one end having a male thread, an end portion of the end having the male thread forms a threaded end opening, and the male thread is provided to engage with a female thread of the nut 2. The nut 2 includes one end having the female thread for engaging with the male thread of the connector main body 1. An outer side end of the retaining ring 6 and an outer side end of the sealing ring 4 respectively abut against a clamping end of the nut 2 and a threaded end opening of the connector main body 1. One end of the supporting ring 5 presses against an inner side end of the retaining ring 6, and a right angled cooperative connection is formed between the other end of the supporting ring 5 and an inner side end of the sealing ring 4.

In the tube connector sealing structure having the above structure, contact surfaces of the sealing ring 4 and the supporting ring 5 abut against with each other in the right angled cooperative connection manner. When mounting the sealing ring 4 and the supporting ring 5, the sealing ring 4 may be closely connected with the supporting ring 5, such that the right angled cooperative connection structure between the sealing ring 4 and the supporting ring 5 may limit the position of the sealing ring 4 in a radial direction of the tube 3, which may prevent the sealing ring 4 from being dislocated or playing in the radial direction of the tube 3, and prevent the sealing ring 4 from being stuck in a gap between the retaining ring 6 and the connector main body 1, such that the sealing member may closely abut against the supporting ring 5, an outer wall of the tube 3, and the end opening of the threaded connecting end of the connector main body 1, thereby ensuring the sealing effect. Furthermore, a contact gap between the sealing ring 4 and the supporting ring 5 is of an L shape, such that a path through which the external water enters is changed, and a difficulty for the entering of the external water is increased, thereby improving the sealing effect.

In a specific solution, as shown in FIGS. 4 and 5, the inner side end of the sealing ring 4 has a right angled groove, the corresponding end of the supporting ring 5 has a right angled protrusion, and the right angled groove and the right angled protrusion form the right angled cooperative connection. In this solution, since the sealing ring 4 is a flexible member, and the supporting ring 5 is a rigid member, the right angled protrusion of the supporting ring 5 may press against the right angled groove of the sealing ring 4, thereby achieving a good sealing effect.

It can be appreciated that, the right angled cooperative connection structure formed by the supporting ring 5 and the sealing ring 4 may also be formed in the following way. The inner side end of the sealing ring 4 has a right angled protrusion, the corresponding end of the supporting ring 5 has a right angled groove, and the right angled groove and the right angled protrusion form a right angled cooperative connection. This solution should also fall into the protection scope of the present application.

In a further solution, a front end surface of the right angled groove of the sealing ring 4 is an inclined surface, and a rear end surface of the right angled protrusion of the supporting ring 5 abuts against the inclined surface. This kind of structure may increase the contact area between the sealing ring 4 and the supporting ring 5, and lengthen the path through which the external water enters. The inclined surface of the end, cooperating with the supporting ring 5, of the sealing ring 4, is pressed by an inclined surface of the supporting ring 5, thus is contracted inwards to press the outer wall of the tube 3, such that the external water can not flow into the tube through the outer wall of the tube 3, thereby improving the sealing effect.

In a preferred solution, the other end of the supporting ring 5 is an inclined surface for pressing against the inner side end of the retaining ring 6. Due to this kind of structure, when screwing the nut 2, the supporting ring 5 may press the retaining ring 6 tightly, such that the retaining ring 6 may be tightened rapidly, and in turn clamp the tube 3.

In a further solution, the end surfaces of the outer side end of the retaining ring 6 and the outer side end of the sealing ring 4 respectively abut against the end surface of the claming end of the nut 2 and the threaded end opening of the connector main body 1. As shown in FIG. 1, for tightly pressing the retaining ring 6, the supporting ring 5 and the sealing ring 4, the threaded end opening of the connector main body 1 has an inclined surface, and the end surface of the corresponding end of the sealing ring 4 is also an inclined surface for cooperating with the inclined surface of the connector main body 1; and an inner side of the clamping end of the nut 2 is also an inclined surface, and correspondingly, the corresponding end of the retaining ring 6 also has an inclined surface for cooperating with the inclined surface of the nut 2.

According to the above description, a main sealing effect of the present application is to realize the sealing between the sealing ring 4 and the outer wall of the tube 3, and also realize the sealing between the sealing ring 4, and each of the connector main body 1 and the supporting ring 5, such that the external water can not flow into the tube 3 through the outer wall of the tube 3, or through the threaded portion of the connector main body 1, or through the L-shaped surface of the supporting ring 5. Further, two sides of the sealing ring 4 are both an inclined surface, the outer side end has a single inclined surface, and the inner side end is an L-shaped end portion having an inclined surface, such that the sealing ring 4 may form two sealing portions. One sealing portion is a sealing between the sealing ring 4 and the threaded end of the connector main body 1 and a sealing between the sealing ring 4 and the outer wall of the tube 3, and the second sealing portion is a sealing between the sealing ring 4 and the supporting ring 5 and a sealing between the sealing ring 4 at the cooperating end of the supporting ring 5 and the outer wall of the tube 3, thereby forming two protection seals and realizing a better sealing effect.

In the above embodiment, the tube connector sealing structure may be mounted in the following manner. The sealing ring 4 is pressed against the threaded end opening of the connector main body 1, the supporting ring 5 is pressed against the sealing ring 4, the retaining ring 6 is pressed against the supporting ring 5, and then the clamping end of the nut 2 is pressed against the retaining ring 6. The present application is not limited to the above mounting manner, and the tube connector sealing structure may also be mounted in the following manner as shown in FIGS. 6, 7 and 8. The sealing ring 4 is pressed against the clamping end of the nut 2, the supporting ring 5 is pressed against the sealing ring 4, the retaining ring 6 is pressed against the supporting ring 5, and then the threaded end opening of the connector main body 1 is pressed against the retaining ring 6. The above two solutions should both fall into the protection scope of the present application.

The present application further provides a tube connector. As shown in FIGS. 2 and 3, the tube connector includes a connector main body 1, and each of two ends of the connector main body 1 includes a threaded connecting end. One threaded connecting end of the connector main body 1 is connected with a nut 2, a tube 3, and the above sealing ring 4, the above supporting ring 5, and the above retaining ring 6. The other threaded connecting end of the connector main body 1 is mounted with a locknut 7 and a stop collar 8. A tube connector sealing structure formed by the sealing ring 4, the supporting ring 5 and the retaining ring 6 is the tube connector sealing structure in the above embodiments. Since the above tube connector sealing structure has the above technical effects, the tube connector having the above tube connector sealing structure should also have the corresponding technical effects.

The tube connector according to the present application is not limited to the above structure. As shown in FIGS. 9, 10 and 11, the tube connector includes a connector main body, and each of two ends of the connector main body has a threaded connecting end. One threaded connecting end of the connector main body is connected with a first nut 12, a first tube 13, a first sealing ring 14, a first supporting ring 15 and a first retaining ring 16. The other threaded connecting end of the connector main body is mounted with a second nut 22, a second tube 23, a second sealing ring 24, a second supporting ring 25, and a second retaining ring 26. Specifically, both of a tube connector sealing structure formed by the first sealing ring 14, the first supporting ring 15 and the first retaining ring 16, and a tube connector sealing structure formed by the second sealing ring 24, the second supporting ring 25 and the second retaining ring 26 are the tube connector sealing structure in the above embodiments. Since the above tube connector sealing structure has the above technical effects, the tube connector having the above tube connector sealing structure should also have the corresponding technical effects.

The above content is only the description of the preferred embodiments of the present application. It should be noted that, due to the limitation of the literal expression and limitless specific structures objectively, for the person skilled in the art, many modifications and improvements may be made to the present application without departing from the principle, scope, and spirit of the present application, and these modifications and improvements are also deemed to fall into the protection scope of the present application.

1. A tube connector sealing structure, configured to seal connecting portions among a tube, a connector main body and a nut, comprising a sealing ring, a supporting ring, and a retaining ring which are all arranged at an outer side of the tube,
wherein an outer side end of the retaining ring and an outer side end of the sealing ring respectively abut against a threaded end opening of the connector main body and a clamping end of the nut, or an outer side end of the retaining ring and an outer side end of the sealing ring respectively abut against a clamping end of the nut and a threaded end opening of the connector main body; and
one end of the supporting ring presses against an inner side end of the retaining ring, and a right angled cooperative connection is formed between the other end of the supporting ring and an inner side end of the sealing ring.

2. The tube connector sealing structure according to claim 1, wherein
the inner side end of the sealing ring has a right angled groove, a corresponding end of the supporting ring has a right angled protrusion, and a right angled cooperative connection is formed by the right angled groove and the right angled protrusion.

3. The tube connector sealing structure according to claim 2, wherein
a front end surface of the right angled groove is an inclined surface, and a rear end surface of the right angled protrusion abuts against the inclined surface.

4. The tube connector sealing structure according to claim 1, wherein
an inner side end of the sealing ring has a right angled protrusion, a corresponding end of the supporting ring has a right angled groove, and a right angled cooperative connection is formed by the right angled groove and the right angled protrusion.

5. The tube connector sealing structure according to claim 1, wherein
one end of the supporting ring is an inclined surface configured to press against the inner side end of the retaining ring.

6. The tube connector sealing structure according to claim 2, wherein
one end of the supporting ring is an inclined surface configured to press against the inner side end of the retaining ring.

7. The tube connector sealing structure according to claim 3, wherein
one end of the supporting ring is an inclined surface configured to press against the inner side end of the retaining ring.

8. The tube connector sealing structure according to claim 4, wherein
one end of the supporting ring is an inclined surface configured to press against the inner side end of the retaining ring.

9. The tube connector sealing structure according to claim 1, wherein
end surfaces of the outer side end of the retaining ring and the outer side end of the sealing ring respectively abut against the threaded end opening of the connector main body and an end surface of the clamping end of the nut; or end surfaces of the outer side end of the retaining ring and the outer side end of the sealing ring respectively abut against an end surface of the clamping end of the nut and the threaded end opening of the connector main body.

10. A tube connector, comprising a connector main body, each of two ends of the connector main body having a threaded connecting end, wherein at least one threaded connecting end of the connector main body is connected with a nut, a tube, and the tube connector sealing structure according to claim 1.

11. The tube connector according to claim 10, wherein the threaded connecting end at each of the two ends of the connector main body is connected with a nut, a tube, and the tube connector sealing structure.

12. The tube connector according to claim 10, wherein the threaded connecting end at one end of the connector main body is connected with a nut, a tube, and the tube connector sealing structure, and the threaded connecting end at the other end of the connector main body is connected with a locknut and a stop collar.
